(19) United States
(12) Patent Application Publication
(10) Pub. No.: US 2020/0102488 A1
(43) Pub. Date: Apr. 2, 2020

(54) METHODS FOR IMPROVED OR ENHANCED OIL RECOVERY

(71) Applicant: Naveed Aslam, Bellaire, TX (US)

(72) Inventor: Naveed Aslam, Bellaire, TX (US)

(21) Appl. No.: 16/148,152

(22) Filed: Oct. 1, 2018

(51) Int. Cl. C09K 8/594; E21B 43/16

(52) U.S. Cl. CPC C09K 8/594; E21B 43/168

(57) ABSTRACT

The present invention relates to a method for increasing the density of a foamed mixture for fracturing subterranean formations. The foamed mixture is formed by adding particles to a Y-Grade material before combing with the inert gas.

### BACKGROUND OF THE INVENTION

During enhanced oil recovery operations, additives can be added to the hydrocarbons present in an oil reservoir to assist in recovering the hydrocarbons. For example, raw natural gas liquids such as Y-Grade hydrocarbons are added with nitrogen to hydrocarbons in reservoirs to assist in the recovery of the hydrocarbons. These additive combinations may be added in the form of foam to assist in their introduction into the hydrocarbons and reduce the mobility of more energized phase such as inert gas nitrogen. Foams could also be instrumental in blocking the high permeability zones and directing gases or hydrocarbon liquids to oil phase thus, providing better contact and hence improving oil recovery.

One problem with the introduction of these additives as a foam or their natural state is that they are less dense than the hydrocarbons that are present in the reservoir. This can cause problems because the additive will float to the top of the hydrocarbons in the reservoir and will be less effective in assisting in recovering hydrocarbons or providing proper miscibility as in order, to form the foam at right location the Y-grade bearing surfactants needs to be retained well within oil bearing zones. Since Y-grade liquids and Y-grade/Nitrogen based foams are lighter the buoyancy effects will be faster than the back mixing effects to achieve complete miscibility so it seems likely that a lighter Y-grade phase could form at the top of oil reservoir and once nitrogen is passed through it could provide a foam zone which is floating on oil & water layer of reservoir thus reducing the intended functionality of diverting inert gas or foam into oil zone.

The additives, particularly when in the form of a foam will buoy upwards at the injection point due to the differences in the densities of the reservoir fluids and the foam. As a result of this buoyancy effect, no miscibility layer is created and the additives remain as a separate upper layer thereby not contacting the majority of the reservoir fluids.

The lighter nitrogen Y-Grade mixture foams will tend to segregate themselves in the upper regions of a reservoir thereby lowering their overall effectiveness at enhanced oil recovery which can produce two issues for enhanced oil recovery applications, namely low density and low viscosity.

Accordingly, the methods of the present invention are designed to address this shortcoming and improve the enhanced recovery of oils from hydrocarbon-bearing reservoirs.

### SUMMARY OF THE INVENTION

In a first embodiment of the invention, there is disclosed a method for increasing density of a foamed mixture comprising a mixture of Y-Grade materials and an inert gas comprising the steps of adding particles to the Y-Grade materials before combining the particles and Y-Grade materials with the inert gas.

In a second embodiment of the invention, there is disclosed a method for enhanced oil recovery in a hydrocarbon reservoir comprising the steps:

Adding particles to a Y-Grade material;

Feeding the Y-Grade material containing particles to the hydrocarbon reservoir;

Feeding an inert gas to the hydrocarbon reservoir, wherein the inert gas contacting the Y-Grade material will form a foam in the hydrocarbon reservoir.

In a further embodiment of the invention, there is disclosed a method for enhanced oil recovery in a hydrocarbon reservoir comprising the steps:

Adding particles to a Y-Grade material;

Feeding the Y-Grade material containing particles to the hydrocarbon reservoir;

Feeding an inert gas to the hydrocarbon reservoir, wherein the inert gas contacting the Y-Grade material will form a foam in the hydrocarbon reservoir and the particles will increase the density of the foam thereby formed.

The inert gas will typically be nitrogen.

The enhanced oil recovery is performed on a reservoir that contains hydrocarbons. The enhanced oil recovery will assist in recovering more hydrocarbons from the reservoir.

The hydrocarbon reservoirs that can be treated are selected from both conventional reservoirs and unconventional reservoirs.

In order to reduce the buoyancy effects of reservoir fluids on the nitrogen and Y-Grade mixture foam, the particles are dissolved into the Y-Grade materials portion of the foam. This dissolution will increase the density and gravity of the foam and provide the foam enough time to be miscible with the hydrocarbons present in the reservoir.

For purposes of the present invention, the particles that may be added to the mixture of nitrogen and Y-Grade materials is limestone. Alternatively, fly ash, beach sand or magnesium silicate rock may be added to the mixture of nitrogen and Y-Grade materials.

The particles can be higher density materials that do not need to be ultrafine in size but can be between 10 microns and 500 microns in diameter size. As such, they would not require any extensive size reduction step before being inserted into the foam mixture and therefore it is likely that a natural source of these heavy particles could be the source for directly mixing with nitrogen and Y-Grade natural gas liquids mixtures.

Naturally occurring particles provide a lowest cost option and could be an effective use of what would otherwise be considered waste resources. For example, particles from mine-tailings or waste from a cement kiln or glass processing operation could be employed in the invention.

For purposes of the present invention, it is desirable that the particles enhance the gravity of the Y-Grade and nitrogen foam and further help in stabilizing the foam through a phenomenon called jamming. This phenomenon is described as when the particles are dissolved in a liquid that is the Y-Grade material, they could stabilize the foam by preventing the drainage of liquid thus lowering the chances of foam break-up and increasing its half-life.

Further, the particles could be charged and in their charged form, along with enhancing density and gravity, they could enhance the foamability of the Y-Grade material and nitrogen mixture thereby improving the utility of the mixture.

The particles are added to the foam by inserting or dissolving them first into the Y-Grade materials. Due to their gravity and size, the particles can be dissolved in Y-Grade liquids and introduced into the reservoir. Once introduced, the nitrogen will then be injected into the reservoir and the nitrogen induced shear as well as shear due to the rock matrix will enable in-situ foam generation.

Preferably, the particles will need to be dissolved in the Y-Grade liquid at the surface, and then fed into the reservoir through the fluid motive device used for the Y-Grade materials.

A hydrocarbon solvent could be employed to assist in introducing the particles into the Y-Grade fluids. For example, the particles may first be dissolved or fed into a hydrocarbon selected from the group consisting of ethanol, butanol and hexane before the hydrocarbon and particles are dissolved into the Y-Grade fluids, thereby creating a more homogenous mixture.

Typically, the concentration of particles added to the Y-Grade materials is in the range of about 500 parts per million to about 4000 parts per million.

It is envisioned that mixtures of particles can be employed, namely using particles from different source to create a tunable mixture depending upon the Y-Grade materials composition as well as specific reservoir conditions and applications.

The choice of particles can be related to their general functionality, namely creating sizing or gravity by inducing heaviness in the Y-Grade materials. However, for example, limestone-based particles could be employed in carbonate-based formations while the fly ash and/or silica particles could be employed for sand stone types of applications.

The Y-Grade materials or liquids will be pumped into the reservoir through a fluid motive device such as a Y-Grade capable pump and will be injected into the injection well through injection tubing. When exiting the injection zone, the Y-Grade materials will flow and diffuse throughout the reservoir and will contact the trapped oil in the process.

### DETAILED DESCRIPTION OF THE INVENTION

The particles added to the foam mixture of nitrogen and Y-Grade materials can enhance its gravity reducing effects by increasing the density of the and improving the overall recovery of hydrocarbons from the reservoir. The particles are heavier than the foam mixture and are abundantly available at much lower cost so they can be dissolved in the Y-Grade natural gas liquids during the foaming process thereby resulting in relatively heavier foam and providing better miscibility with the reservoir fluids.

The mixture of nitrogen and Y-Grade materials is typically a ratio of 90:10 or 50:50, and is preferably in the form of a foam when it is added to the reservoir. The nitrogen and Y-Grade material foam is typically nitrogen gas dispersed in raw natural gas liquids. For more effective mixing to occur, the Y-Grade materials are first added to the reservoir and the inert gas is then fed to the reservoir.

In general, Y-grade fluids comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

The density of high pressure natural gas liquids at typical hydrocarbon miscible conditions is roughly 0.5 gm/cm³. At enhanced oil recovery conditions of temperature about 20 to 80° C., pressure of 300 to 2500 psi, ethane, propane and butane have a density of roughly 0.4 gm/cm³, 0.5 gm/cm³ and 0.6 gm/cm³ respectively. The density of nitrogen gas is even lower at 0.1413 gm/cm³ for reservoir conditions. As such, a 90:10 or 50:50 ratio foam mixture will have a lower density of 0.177 gm/cm³ for 90:10 mixture foam and 0.32 gm/cm³ for 50:50 mixture foam.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for increasing density of a foamed mixture comprising a mixture of Y-Grade materials and an inert gas comprising the steps of adding particles to the Y-Grade materials before combining the particles and Y-Grade materials with the inert gas and increasing the density of the foamed mixture with said particles.

2. The method as claimed in claim 1 wherein the inert gas is nitrogen.

3. The method as claimed in claim 1 wherein the foamed mixture is fed to a reservoir that contains hydrocarbons.

4. The method as claimed in claim 1 wherein the reservoir is selected from the group consisting of conventional and unconventional reservoirs.

5. The method as claimed in claim 1 wherein the particles are selected from the group consisting of limestone, fly ash, sand and magnesium silicate rock.

6. The method as claimed in claim 1 wherein the particles are charged particles.

7. The method as claimed in claim 1 wherein the particles are between 10 microns and 500 microns in diameter.

8. A method for enhanced oil recovery in a hydrocarbon reservoir comprising the steps:
Adding particles to a Y-Grade material;
Feeding the Y-Grade material containing particles to the hydrocarbon reservoir;
Feeding an inert gas to the hydrocarbon reservoir, wherein the inert gas contacting the Y-Grade material will form a foam in the hydrocarbon reservoir.

9. The method as claimed in claim 8 wherein the inert gas is nitrogen.

10. The method as claimed in claim 8 wherein the reservoir is selected from the group consisting of conventional and unconventional reservoirs.

11. The method as claimed in claim 8 wherein the particles are selected from the group consisting of limestone, fly ash, sand and magnesium silicate rock.

12. The method as claimed in claim 8 wherein the particles are charged particles.

13. The method as claimed in claim 8 further comprising adding the particles to a hydrocarbon before adding the particles to the Y-Grade material.

14. The method as claimed in claim 8 wherein the particles comprise mixtures of particles.

15. The method as claimed in claim 8 wherein the particles are between 10 microns and 500 microns in diameter.

16. A method for enhanced oil recovery in a hydrocarbon reservoir comprising the steps:
Adding particles to a Y-Grade material;
Feeding the Y-Grade material containing particles to the hydrocarbon reservoir;
Feeding an inert gas to the hydrocarbon reservoir, wherein the inert gas contacting the Y-Grade material will form a foam in the hydrocarbon reservoir and the particles will increase the density of the foam thereby formed.

17. The method as claimed in claim 16 wherein the inert gas is nitrogen.

18. The method as claimed in claim 16 wherein the reservoir is selected from the group consisting of conventional and unconventional reservoirs.

19. The method as claimed in claim 16 wherein the particles are selected from the group consisting of limestone, fly ash, sand and magnesium silicate rock.

20. The method as claimed in claim 16 wherein the particles are charged particles.

21. The method as claimed in claim 16 further comprising adding the particles to a hydrocarbon before adding the particles to the Y-Grade material.

22. The method as claimed in claim 16 wherein the particles comprise mixtures of particles.

23. The method as claimed in claim 16 wherein the particles are between 10 microns and 500 microns in diameter.
